(19) United States
(12) Patent Application Publication
(10) Pub. No.: US 2013/0016309 A1
(43) Pub. Date: Jan. 17, 2013

(54) Backlight module and liquid crystal display using the same

(71) Applicants: Lifeng Wang, Shenzhen (CN); Yajun Yu, Shenzhen (CN)

(72) Inventors: Lifeng Wang, Shenzhen (CN); Yajun Yu, Shenzhen (CN)

(73) Assignee: Shenzhen China Star Optoelectronics Technology Co., Ltd., Shenzhen (CN)

(21) Appl. No.: 13/380,869

(22) PCT Filed: Dec. 3, 2011
(86) PCT No.: PCT/CN11/83426

§ 371 Date: Dec. 26, 2011

(30) Foreign Application Priority Data
Jul. 14, 2011 (CN) 201120246559.8

(51) Int. Cl. G02F 1/1335; G09F 13/04

(52) U.S. Cl. 349/62; 362/602

(57) ABSTRACT

The utility model discloses a backlight module and a liquid crystal display (LCD) using the backlight module. The backlight module comprises a light guide plate and a clamp for fixing the light guide plate. The light guide plate is formed by splicing of more than two sub-light guide plates. The backlight module used for the LCD of the utility model is characterized in that sub-light guide plates of modular design are used, and the light guide plate applicable to any sizes of the LCD can be formed by splicing of the sub-light guide plates. The backlight module has advantages of convenient processing and assembly, productivity improvement, material waste reduction and backlight module cost decrease.

### TECHNICAL FIELD

The utility model relates to the field of liquid crystal displays, in particular to a backlight module and a liquid crystal display (LCD) using the backlight module.

### BACKGROUND

At present, with the development of industry chain and reduction of costs, liquid crystal displays become main products in the display market. Liquid crystal itself does not illuminate. Therefore, each liquid crystal display is provided with a backlight source, and the backlight source scatters through a light guide plate to provide homogeneous white light for liquid crystal panels. Existing light guide plates are in an integratedly formed structure. Liquid crystal displays have varying sizes, so it is necessary to design and manufacture a corresponding light guide plate for each size of the liquid crystal displays. Therefore, the existing light guide plates have disadvantages of low efficiency, high cost, inconvenient production and assembly in an overall cutting mode, particularly for large liquid crystal displays, wastes of leftover materials and material cost increase.

### SUMMARY

The utility model aims to provide a backlight module comprising a low-cost and flexibly-assembled light guide plate, and a liquid crystal display using the backlight module.

The aim of the utility model is achieved by the following technical schemes:

A backlight module comprises a light guide plate and a clamp for fixing the light guide plate. The light guide plate is formed by splicing of more than two sub-light guide plates.

Preferably, the clamp is provided with bayonets, the ends of the sub-light guide plates are provided with lugs for fitting the bayonets of the clamp, and the sub-light guide plates are fixed on the clamp by fitting of the lugs and the bayonets. Fitting of the lugs and the bayonets is favorable for standardized design of the light guide plate and the clamp.

Preferably, side walls of the bayonets are presented as a wedge bevel, and the top of each bayonet is wider than the bottom. The side walls of the wedge bayonets are presented as a bevel. After the lugs of the sub-light guide plates are arranged in the bayonets, the sub-light guide plates can generate a horizontal component on the bevels under the pressure of other structures, such as an upper rubber frame, a liquid crystal display module, etc., to ensure close splicing of two adjacent sub-light guide plates.

Preferably, the lugs comprise necks and heads, the necks of the lugs are connected with the sub-light guide plates and are fitted with the bayonets of the clamp, the width the necks of the lugs corresponds to that of the bayonets of the clamp, and the heads of the lugs are wider than the necks of the lugs. The necks of the lugs are narrower than the heads to form a hook structure. The structure can prevent the lugs from separating from the bayonets in a horizontal direction after the sub-light guide plates are arranged in the bayonets.

Preferably, two side walls of the bayonets are of a bevel, bottoms of the bayonets are of a plane, and the bottoms and the side walls form an obtuse angle; the sides of the necks of the lugs fitted with the bayonets, which are tangent with the side walls of the bayonets, are of a corresponding bevel; the sides of the necks of the lugs fitted with the bayonets, which are tangent with the bottoms of the bayonets, are of a plane; the included angle formed by the bevel and the plane of the necks of the lugs are the same as the included angle formed by the bottoms and side walls of the bayonets. Faying surfaces of the lugs and the bayonets are corresponding to each other, so the stress is more well-distributed, and abrasion is avoided due to too high stress in partial areas.

Preferably, each of the sub-light guide plates has two lugs which connect with the clamp on one end of the sub-light guide plate, the two lugs are respectively arranged on two corners at one end of the sub-light guide plate, two adjacent lugs of the two adjacent sub-light guide plates are respectively fitted with a bayonet of the clamp, and the side walls of the two mutually tangent lugs are of a close-fitting plane. Two adjacent lugs of the two sub-light guide plates are spliced in the same bayonet, so close splicing of two adjacent sub-light guide plates can be achieved more easily.

Preferably, the bayonets are in the shape of a right-angled trapezoid, and the top of each bayonet is wider than the bottom; the bottoms of the bayonets are of a plane, the side wall on one end is of a bevel, and the side wall on the other end is of a plane vertical to the bottom; the bevel and the bottom form an obtuse angle, and the bevels of all the bayonets keep on the same side; each side of sub-light guide plates fixed on the clamp has one lug, each lug is corresponding to one bayonet, and the lugs are of the same shape as the bayonets. The design of a lug can realize simpler design of the sub-light guide plates to reduce manufacture cost of the sub-light guide plates.

Preferably, the clamp also comprises a strip base plate and a baffle, the baffle is vertically arranged on one side of the base plate, the other side of the base plate is provided with clips, and two adjacent clips form the bayonet. The side walls at the two ends of the clips are used to form the natural bayonets, so cost is low.

Preferably, the backlight module used for the LCD has LED lights, and the LED lights are equidistantly arranged on the baffle. The LED lights are arranged on the clamp to make use of space of the backlight module more reasonably and reduce volume of the backlight module. The equidistant installation of LED lights can enable the light guide plate to scatter more homogeneous light.

Preferably, the backlight module for the LCD comprises LED lights arranged on the baffle, and the clips comprise paired blocks; the blocks of the adjacent clips form the bayonets, the two blocks in the clips form notches, and the LED lights are arranged in positions corresponding to the notches. The LED lights are corresponding to the notches, so clearances between the clips and the baffle can be fully utilized, and width of the frame of the backlight module can be reduced.

A liquid crystal display comprises a liquid crystal panel and the aforementioned backlight module.

The backlight module used for the LCD of the utility model is characterized in that sub-light guide plates of modular design are used, and the light guide plate applicable to any sizes of the LCD can be formed by splicing of the sub-light guide plates. The backlight module has advantages of convenient processing and assembly, productivity improvement, material waste reduction and backlight module cost decrease.

### DESCRIPTION OF FIGURES

FIG. 1 is an exploded view for assembly of the embodiment 1 of the utility model.

FIG. 2 is an outside view of a clamp of the embodiment 1 of the utility model.

FIG. 3 is a section view of a clamp bayonets of the embodiment 1 of the utility model.

FIG. 4 is a top view of the embodiment 1 of the utility model.

FIG. 5 is an A-A section view of FIG. 4 of the embodiment 1 of the utility model.

FIG. 6 is a top view of the embodiment 2 of the utility model.

FIG. 7 is a B-B section view of FIG. 4 of the embodiment 2 of the utility model.

FIG. 8 is a top view of the embodiment 3 of the utility model.

Wherein: 1, clamp; 2, bayonet; 3, sub-light guide plate; 4, lug; 5, LED light; 6, PCB; 7, block; 8, baffle; 9, clip.

### DETAILED DESCRIPTION

The utility model is further described in accordance with figures and the preferred embodiments as follows.

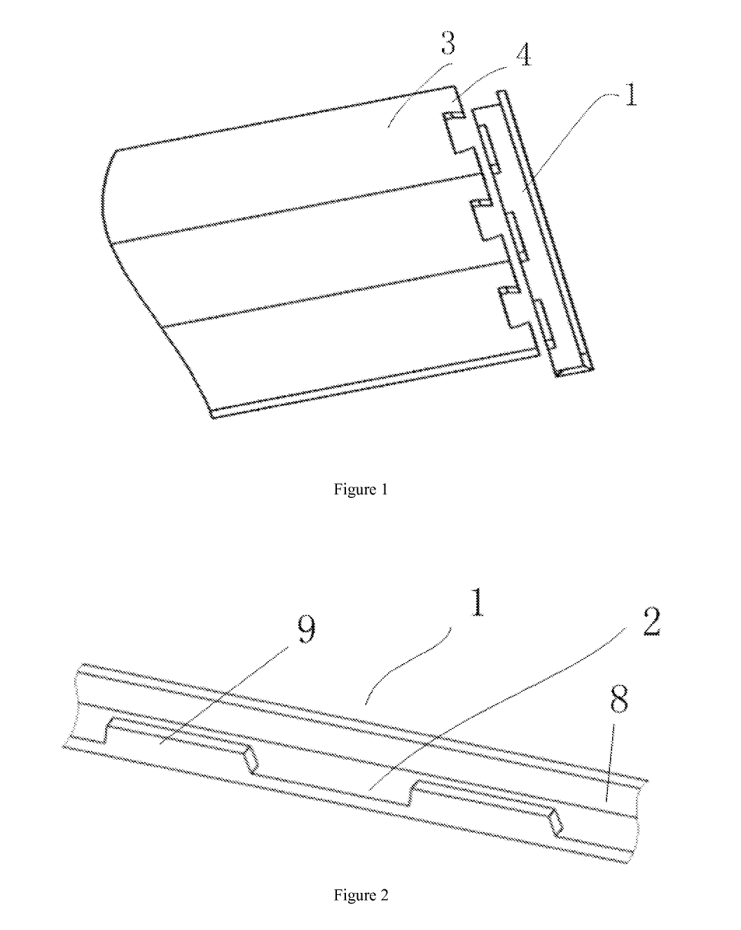

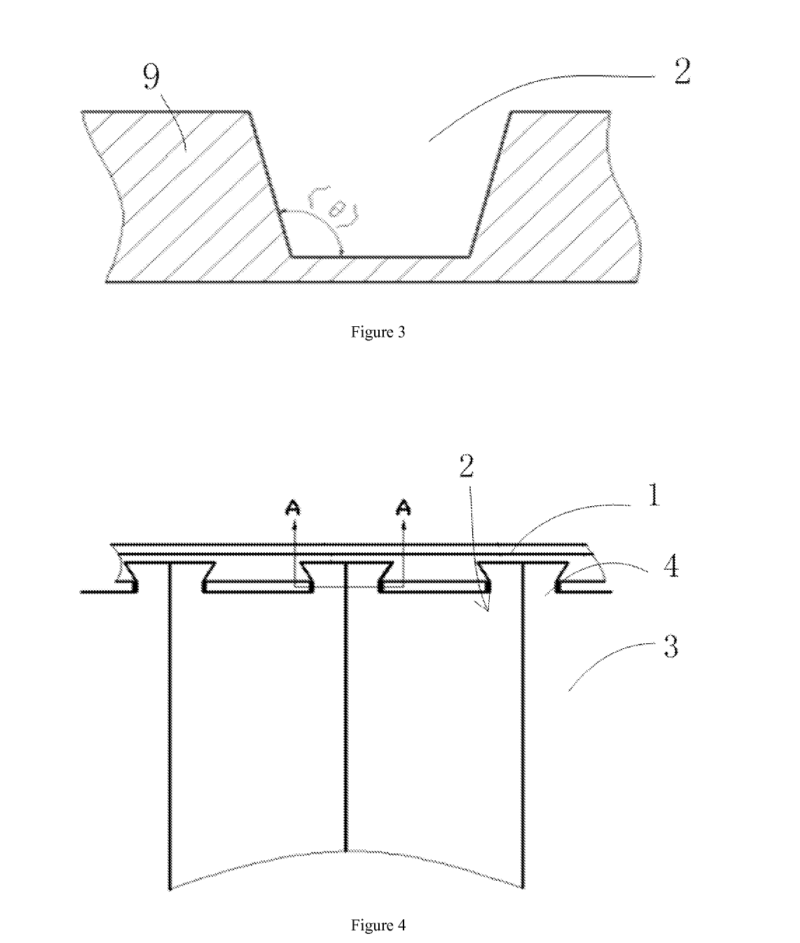

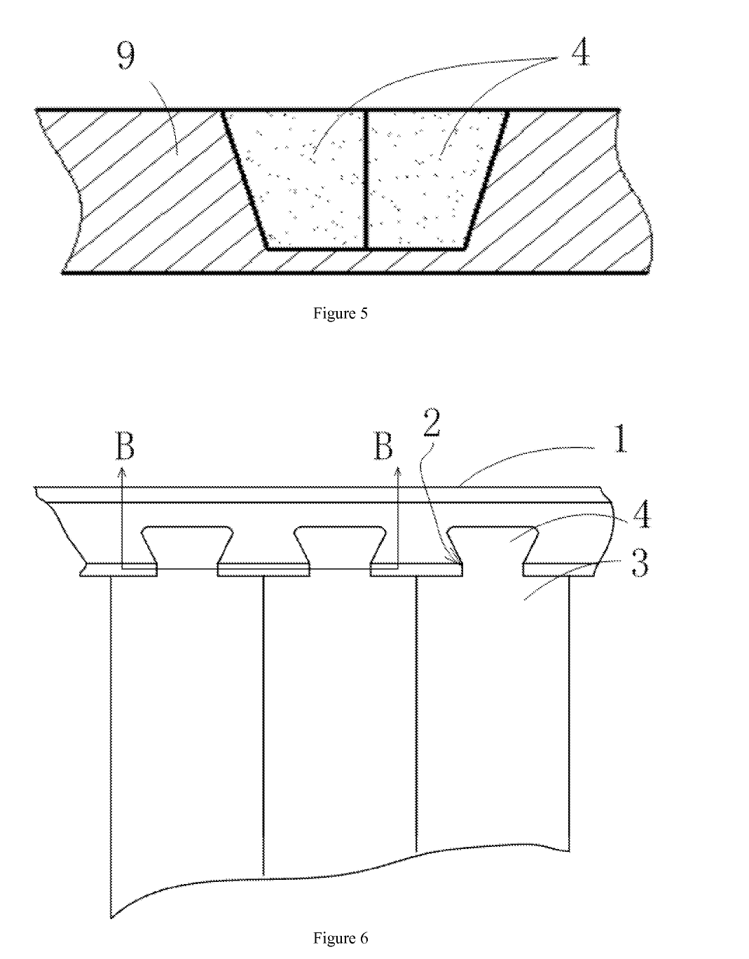

As shown in FIG. 1 to FIG. 8, the backlight module of the embodiments of the utility model comprises a backlight source, more than two sub-light guide plates 3 and clamps 1 of the sub-light guide plates 3. The sub-light guide plates 3 form a light guide plate applicable to various sizes of liquid crystal displays in a splicing mode.

For the specific splicing mode, the convex clips 9 are arranged on the clamp 1, and two adjacent clips 9 form a bayonet 2. Correspondingly, the sub-light guide plates 3 are provided with lugs 4 fitted with the bayonets 2. Therefore, as long as the bayonets 2 have an appropriate spacing, close splicing of two adjacent sub-light guide plates 3 can be ensured after the lugs 4 are arranged in the bayonets 2. The splicing mode is favorable for modularized and standardized design and production of the sub-light guide plates 3 and the clamp 1 and provides convenience for processing, particularly for the clamp 1. The clamp 1 can be made to a standard section and cut to any length in accordance with the sizes of the liquid crystal panel. The splicing mode has advantages of convenience and less waste of materials. Other splicing modes of the sub-light guide plates 3 are all within the protection extent of the utility model.

The backlight module used for the LCD is characterized in that sub-light guide plates 3 of modular design are used, and the light guide plate applicable to any sizes of the LCD can be formed by splicing of the sub-light guide plates 3. The backlight module has advantages of convenient processing and assembly, productivity improvement, material waste reduction and backlight module cost decrease. The concept of the utility model is further described in terms of the fitting mode of the lugs 4 and the bayonets 2.

Embodiment 1: As shown in FIG. 1 to FIG. 5, the bayonets 2 are wedge shaped, and the tops of the bayonets 2 are wider than the bottoms; both side walls of the bayonets 2 are of a bevel, the bottoms are of a plane, and the bottoms and the side walls form an obtuse angle. The lugs 4 comprise necks and heads. The necks of the lugs 4 are connected with the sub-light guide plates 3, the width of the necks corresponds to that of the bayonets 2 of the clamp 1, and the heads of the lugs 4 are wider than the necks of the lugs 4. The sides of the necks of the lugs 4, which are tangent with the side walls of the bayonets 2, are of a corresponding bevel; the sides of the necks of the lugs, which are tangent with the bottoms of the bayonets 2, are of a plane; the included angles formed by the bevels and the planes of the necks of the lugs 4 are the same as that formed by the bottoms and side walls of the bayonets 2. The end of the sub-light guide plates 3 fixed on the clamp 1 has two lugs 4 on the two corners, two adjacent lugs 4 on two sub-light guide plates 3 are arranged in the same bayonet 2, and the faying side wall of the two lugs 4 is a vertical plane. Under the pressure of other structures, such as an upper rubber frame, a liquid crystal display module, etc., the two lugs 4 generate two contrary horizontal stresses on the two bevels of the bayonet 2, so that the two sub-light guide plates 3 squeeze each other to achieve reliable splicing. The two lugs 4 are mutually interacted in the same bayonet 2, so the mode ensures closer splicing of the two adjacent sub-light guide plates 3. In addition, the heads of the lugs 4 are wider than the necks, so the sub-light guide plates 3 cannot slip off in a horizontal direction once the lugs 4 are arranged in the bayonets 2, and installation becomes more reliable. Other splicing modes achieved by arranging the lugs 4 in the bayonets 2 are all within the protection extent of the utility model.

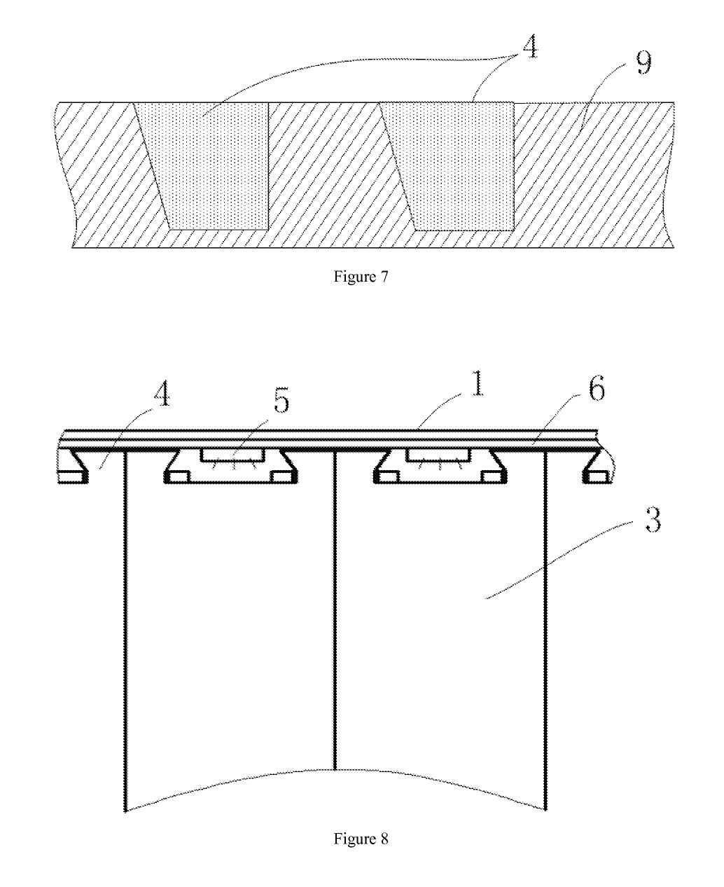

Embodiment 2: As shown in FIG. 6 and FIG. 7, the bayonets 2 are in a shape of a right-angled trapezoid, and the tops of the bayonets 2 are wider than the bottoms; the bottoms of the bayonets 2 are of a plane, one side wall is a bevel, and the other side wall is a plane vertical to the bottom, the bevel and the bottom form an obtuse angle, and all the bevels of the bayonets 2 keep on the same side. Each sub-light guide plate 3 has only one lug 4, and each lug 4 is corresponding to one bayonet 2. The lugs 4 comprise necks and heads. The necks of the lugs 4 are connected with the sub-light guide plates 3, the width of the necks correspond to that of the bayonets 2 of the clamp 1, the heads of the lugs 4 are wider than the necks of the lugs 4, and the necks of the lugs 4 have the same shape as the bayonets 2. All the bevels of the bayonets 2 keep on the same side, so all the sub-light guide plates 3 deflect in the same direction under the pressure of other structures, such as an upper rubber frame and a liquid crystal display module, etc. Close splicing of two adjacent sub-light guide plates 3 can be achieved, as long as the bayonets have adequate design margin. The design of a lug 4 can realize simpler design of the sub-light guide plates 3 to reduce manufacture cost of the sub-light guide plates 3. Other splicing modes achieved by arranging the lugs 4 in the bayonets 2 are all within the protection extent of the utility model.

Embodiment 3: As shown in FIG. 8, the clamp 1 comprises a strip base plate and a baffle 8. The baffle 8 is vertically arranged on one side of the base plate, the other side of the base plate is provided with the clips 9, and the LED lights 5 are equidistantly arranged on the baffle 8. The LED lights 5 can be arranged on the PCB 6 to achieve reliable electrical connection, and then, the PCB 6 is fixed to the baffle 8. Other modes to make the LED lights 5 illuminate, such as wiring connection, etc. are also within the protection extent of the utility model. Preferably, the clips 9 comprise paired blocks 7, the blocks 7 of the adjacent clips 9 form the bayonets 2, the two blocks 7 in the clips 1 form notches, and the LED lights are arranged in positions corresponding to the notches. Equidistant installation of the LED lights can ensure light radiating to the light guide plate to be homogeneous. The clips 9 comprise paired blocks 7, the blocks 7 can automatically form notches, and a spacing exists between the blocks 7 and the baffle 8. Therefore, the LED lights 5 are arranged on the baffle 8 corresponding to the notches, and light can directly radiate to the light guide plate through the notches. In this mode, the spacing between the clips 9 and the baffle 8 is fully utilized, which is favorable to reducing the width of the frame of the backlight module. The embodiment is applicable to all the clamp 1 with the bayonets 2, including the embodiment 1 and the embodiment 2. Other modes to arrange the LED lights on the clamp 1 are all within the protection extent of the utility model.

The utility model is described in detail in accordance with the above contents with the specific preferred embodiments. However, the utility model is not limited to the specific embodiments. For the ordinary technical personnel of the technical field of the utility model, on the premise of keeping the conception of the utility model, the technical personnel can also make simple deductions or replacements, and all of which should be considered to belong to the protection scope of the utility model.

We claim:

1. A backlight module, comprising: a light guide plate and a clamp for fixing the light guide plate; said light guide plate is formed by splicing of more than two sub-light guide plates.

2. The backlight module of claim 1, wherein said clamp is provided with bayonets, the ends of said sub-light guide plates are provided with lugs for fitting the bayonets of the clamp, and said sub-light guide plates are fixed on the clamp by fitting of the lugs and the bayonets.

3. The backlight module of claim 2, wherein side walls of said bayonets are presented as a wedge bevel, and the top of each bayonet is wider than the bottom.

4. The backlight module of claim 2, wherein said lugs comprise necks and heads, the necks of said lugs are connected with the sub-light guide plates and fitted with the bayonets of the clamp, the width of the necks of said lugs corresponds to that of the bayonets of the clamp, and the heads of the lugs are wider than the necks of the lugs.

5. The backlight module of claim 2, wherein two side walls of said bayonets are of a bevel, bottoms of said bayonets are of a plane, and the bottoms and the side walls form an obtuse angle; the sides of the necks of said lugs fitted with the bayonets, which are tangent with the side walls of the bayonets, are of a corresponding bevel; the sides of the necks of said lugs fitted with the bayonets, which are tangent with the bottoms of the bayonets, are of a plane; the included angles formed by the bevels and the planes of the necks of the lugs are the same as that of formed by the bottoms and wide walls of the bayonets.

6. The backlight module of claim 5, wherein each of said sub-light guide plates has two lugs connecting with the clamp on one end of the sub-light guide plate, the two lugs are respectively arranged on two corners at one end of the sub-light guide plate, two adjacent lugs of the two adjacent sub-light guide plates are respectively fitted with a bayonet of the clamp, and the side walls of the two mutually tangent lugs are of a close-fitting plane.

7. The backlight module of claim 2, wherein said bayonets are in a shape of a right-angled trapezoid, and the top of each bayonet is wider than the bottom; the bottoms of the bayonets are of a plane, the side wall on one end is of a bevel, and the side wall on the other end is of a plane vertical to the bottom; said bevel and the bottom form an obtuse angle, and the bevels of all the bayonets keep on the same side; each side of said sub-light guide plates fixed on the clamp has one lug, each lug is corresponding to one bayonet, and the lugs are of the same shape as the bayonets.

8. The backlight module of claim 2, wherein said clamp also comprises a strip base plate and a baffle, said baffle is vertically arranged on one side of the base plate, the other side of said base plate is provided with clips, and two adjacent clips form said bayonet.

9. The backlight module of claim 8, wherein said backlight module used for LCD comprises a plurality of LED lights, and the LED lights are equidistantly arranged on the baffle.

10. The backlight module of claim 8, wherein said backlight module used for LCD comprises LED lights arranged on the baffle, and said clips comprise paired blocks; the blocks of the adjacent clips form the bayonets, the two blocks in the clips form notches, and the LED lights are arranged in positions corresponding to the notches.

11. An LCD, comprising a liquid crystal panel and a backlight module; said backlight module comprises a light guide plate and a clamp for fixing the light guide plate, and said light guide plate is formed by splicing of more than two sub-light guide plates.

12. The LCD of claim 11, wherein said clamp is provided with bayonets, the ends of said sub-light guide plates are provided with lugs for fitting the bayonets of the clamp, and said sub-light guide plates are fixed on the clamp by fitting of the lugs and the bayonets.

13. The LCD of claim 12, wherein side walls of said bayonets are presented as a wedge bevel, and the top of each bayonet is wider than the bottom.

14. The LCD of claim 12, wherein said lugs comprise necks and heads, the necks of said lugs are connected with the sub-light guide plates and fitted with the bayonets of the clamp, the width of the necks of said lugs corresponds to that of the bayonets of the clamp, and the heads of said lugs are wider than the necks of said lugs.

15. The LCD of claim 12, wherein two side walls of said bayonets are of a bevel, bottoms of said bayonets are of a plane, and the bottoms and the side walls form an obtuse angle; the sides of the necks of the lugs fitted with the bayonets, which are tangent with the side walls of the bayonets, are of a corresponding bevel; the sides of the necks of the lugs fitted with the bayonets, which are tangent with the bottoms of the bayonets, are of a plane; the included angles formed by the bevels and the planes of the necks of the lugs are the same as that formed by the bottoms and side walls of the bayonets.

16. The LCD of claim 15, wherein each of said sub-light guide plates has two lugs connecting with the clamp on one end of the sub-light guide plate, the two lugs are respectively arranged on two corners at one end of the sub-light guide plate, two adjacent lugs of the two adjacent sub-light guide plates are respectively fitted with a bayonet of the clamp, and the side walls of the two mutually tangent lugs are of a mutually close-fitting plane.

17. The LCD of claim 12, wherein said bayonets are in a shape of a right-angled trapezoid, and the top of each bayonet is wider than the bottom; the bottoms of the bayonets are of a plane, the side wall on one end is of a bevel, and the side wall on the other end is of a plane vertical to the bottom; said bevel and the bottom form an obtuse angle, and the bevels of all the bayonets keep on the same side; each side of said sub-light guide plates fixed on the clamp has one lug, each lug is corresponding to one bayonet, and the lugs are of the same shape as the bayonets.

18. The LCD of claim 12, wherein said clamp also comprises a strip base plate and a baffle, said baffle is vertically arranged on one side of the base plate, the other side of said base plate is provided with clips, and two adjacent clips form said bayonet.

19. The LCD of claim 18, wherein said backlight module comprises a plurality of LED lights, and said LED lights are equidistantly arranged on the baffle.

20. The LCD of claim 18, wherein said backlight module comprises LED lights arranged on the baffle, and said clips comprise paired blocks; the blocks of the adjacent clips form the bayonets, the two blocks in the clips form notches, and the LED lights are arranged in positions corresponding to the notches.
